(19) United States
(12) Patent Application Publication
(10) Pub. No.: US 2026/0073187 A1
(43) Pub. Date: Mar. 12, 2026

(54) TIME SERIES PREDICTION USING CONVOLUTIONAL NEURAL NETWORK - LONG SHORT TERM MEMORY ATTENTION MODEL

(71) Applicant: International Business Machines Corporation, Armonk, NY (US)

(72) Inventors: Zhao Yu Wang, Beijing (CN); Peng Hui Jiang, Beijing (CN); Tian Tian, Beijing (CN); Mai Zeng, Beijing (CN); Qian Yi Wu, Shanghai (CN); Si Ling Chen, Shanghai (CN); Wei Dong Zhao, Shanghai (CN); Liang Dong, Shanghai (CN)

(21) Appl. No.: 18/882,866

(22) Filed: Sep. 12, 2024

(51) Int. Cl. G06N 3/0442; G06N 3/0464

(52) U.S. Cl. CPC G06N 3/0442; G06N 3/0464

(57) ABSTRACT

A method for predicting a next time step data element in a set of time series data includes receiving a one-dimensional time series data set and converting the time series data set to a two-dimensional time series data set. The two-dimensional time series data set is provided to an input of a convolutional neural network-long short term memory (CNN-LSTM) model. The CNN-LSTM model generates the next time series step prediction of the two-dimensional time series data. The method compares the prediction to an actual next time series step and responds to a difference exceeding a first threshold by incrementing an outlier counter. When the outlier counter exceeds a predefined size the method alters the CNN-LSTM model. In addition, a visualization of the next time series step prediction of the two-dimensional time series data is generated.

### BACKGROUND

The present invention generally relates to machine learning based time series predictions, and more specifically, to generating a time series prediction using a convolution neural network-long short term memory model (CNN-LSTM).

Machine learning systems, such as long short term memory models, use statistical algorithms to learn from data and generalize to unseen data. This allows the machine learning systems to perform tasks without explicitly defined steps or instructions. One common application of machine learning systems is to predict an outcome of a system based on multiple factors defining an input.

When using machine learning to make such predictions in real time the number of factors utilized in making a prediction can exponentially increase the length of time that it takes to generate the prediction.

### SUMMARY

Embodiments of the present invention are directed to a computer-implemented method for accurately predicting a next step in a time series data set. A non-limiting example of the computer-implemented method includes a method for predicting a next time step data element in a set of time series data includes receiving a one-dimensional time series data set and converting the time series data set to a two-dimensional time series data set. The two-dimensional time series data set is provided to an input of a convolutional neural network-long short term memory (CNN-LSTM) model. The CNN-LSTM model generates the next time series step prediction of the two-dimensional time series data. The method compares the prediction to an actual next time series step and responds to a difference exceeding a first threshold by incrementing an outlier counter. When the outlier counter exceeds a predefined size the method alters the CNN-LSTM model. In addition, a visualization of the next time series step prediction of the two-dimensional time series data is generated.

Embodiments of the present invention are similarly directed to systems, methods, and computer program products for implementing the same method and for causing a processor and a computer system to implement the method.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts one exemplary cloud computing system configured to implement the system and method according to one embodiment;

FIG. 2 depicts a general process flow for providing real time prediction and training using a convolutional neural network-long short term memory (CNN-LSTM) model;

FIG. 3 depicts an architecture of an example CNN-LSTM attention model;

FIG. 4 depicts an operation of a single layer of the two-dimensional dilated convolutional layer using variable expansion coefficient (2D VEC-DCNN) on a 16 by 16 two-dimensional time series in one example;

FIG. 5 depicts three sequential layers of the 2D VEC-CNN of FIG. 4;

FIG. 6 depicts a multi-head self-attention mechanism; and

FIG. 7 depicts a long short term memory recurrent neural network with host data boundaries (BHI-LSTM) according to one example.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

A computer-implemented method includes receiving, at a processor, a one-dimensional time series data set and converting the time series data set to a two-dimensional time series data set using a processor. The method provides the two-dimensional time series data set to an input of a convolutional neural network-long short term memory (CNN-LSTM) model using the processor and generates a next time series step prediction of the two-dimensional time series data using the CNN-LSTM model. The next time series step prediction is compared to an actual next time series step and responding to a difference between the next time series step prediction and the actual next time series step exceeding a first threshold by incrementing an outlier counter using the processor. The method responds to the outlier counter exceeding a predefined count value by altering the CNN-LSTM model. Lasty, the method generates a visualization of the next time series step prediction of the two-dimensional time series data. The computer-implemented method advantageously provides a more accurate visual representation of a real time prediction of a next step of a time series data set.

In another example, any of the methods described herein can separably or in combination with any other methods described herein, further include normalizing the two-dimensional time series data, providing the normalized two-dimensional time series data to an initial training model and generating a prediction using the initial training model simultaneously with generating the next time series step prediction, comparing an output of the initial training model with the actual next time series step and incrementing the outlier counter using the processor when a difference between the initial training model and the actual time step exceeds a second threshold. The further step advantageously allows the CNN-LSTM model to receive initial training and simultaneous training, thereby further improving a speed at which the model is refined to meet the needs of a specific input.

In another example, any of the methods described herein can separably or in combination with any other methods described herein, the CNN-LSTM includes an input layer for receiving the two-dimensional time series data set and providing the two-dimensional time series data set to a dilated convolutional layer using variable expansion coefficient (VEC-DCNN) configured to generate a dilated convolution of the two-dimensional time series data set, and a multi-headed self actuation layer receiving the generated dilated convolution and providing multi-headed output to a long short term memory recurrent neural network with host data boundaries (BHI-LSTM) configured to generate the next time series step prediction. The inclusion of a VEC-DCNN layer allows the expansion coefficient to be dynamically adjusted, thereby reducing the error between the predicted next step and the actual next step, and the use of a multi-headed self actuation layer improves the ability of the output to conform the characteristics of the input time series.

In another example, any of the methods described herein can separably or in combination with any other methods described herein, the multi-headed self actuation layer includes an embedding layer configured to receive the generated dilated convolution, generate N time series vectors where N is a number of time steps in the generated dilated convolution and to generate a multi-headed output to the BHI-LSTM, wherein the multi-headed output includes N heads with each head corresponding to a distinct component of the N time series vectors. This layer structure further enhances the ability of the self actuation layer to correlate all of the related pieces of information from each input vector into a single head of the output.

In another example, any of the methods described herein can separably or in combination with any other methods described herein, the VEC-CNN includes an input layer for receiving the two-dimensional time series data set and a plurality of sequential dilated convolution layers. The multiple sequential dilated convolution layers assist the time series prediction model in capturing longer-term dependencies, thereby increasing the accuracy of the prediction.

In another example, any of the methods described herein can separably or in combination with any other methods described herein, the sequential dilated convolution layers have variable dilation rates. Variable dilation rates provide a tuning variable that enhances the ability of the CNN-LSTM to be tuned throughout operation of the method.

In another example, any of the methods described herein can separably or in combination with any other methods described herein, altering the CNN-LSTM model includes adjusting a dilation rate of at least convolution layer of the sequential convolution layers thereby allowing the adjustments to better fine tune the outputs of the CNN-LSTM based to meet the particular input host data.

In another example, any of the methods described herein can separably or in combination with any other methods described herein, the BHI-LSTM comprises an input layer, a block Hankel conversion layer configured to convert the multi-headed output to a block Hankel tensor, and a long short term memory (LSTM) model with host data boundaries layer including at least two LSTM layers. The LSTM layers improve the output by preventing the predictions from being too large or too small.

In another example, any of the methods described herein can separably or in combination with any other methods described herein, the block Hankel conversion layer converts the multi-headed output to a block Hankel tensor. Using a block Hankel tensor conversion layer improves the smoothness of the data set, making the resultant data easier to use for learning than raw data.

In another example, a method described herein includes receiving a one-dimensional time series data set and converting the time series data set to a two-dimensional time series data set. The two-dimensional time series data set is provided to an input of a convolutional neural network-long short term memory (CNN-LSTM) model. A next time series step prediction of the two-dimensional time series data is generated using the CNN-LSTM model. The next time series step prediction is compared to an actual next time series step and responding to a difference between the next time series step prediction and the actual next time series step exceeding a first threshold by incrementing an outlier counter. The outlier counter exceeding a predefined count value is responded to by altering the CNN-LSTM model. Generating a visualization of the next time series step prediction of the two-dimensional time series data. The method advantageously provides a more accurate visual representation of a real time prediction of a next step of a time series data set.

In another example, any of the methods described herein can separably or in combination with any other methods described herein, include normalizing the two-dimensional time series data, providing the normalized two-dimensional time series data to an initial training model and generating a prediction using the initial training model simultaneously with generating the next time series step prediction, comparing an output of the initial training model with the actual next time series step and incrementing the outlier counter using the processor when a difference between the initial training model and the actual time step exceeds a second threshold. The further step advantageously allows the CNN-LSTM model to receive initial training and simultaneous training, thereby further improving a speed at which the model is refined to meet the needs of a specific input.

In another example, any of the methods described herein can separably or in combination with any other methods described herein, the CNN-LSTM includes an input layer for receiving the two-dimensional time series data set and providing the two-dimensional time series data set to a dilated convolutional layer using variable expansion coefficient (VEC-DCNN) configured to generate a dilated convolution of the two-dimensional time series data set and a multi-headed self actuation layer receiving the generated dilated convolution and providing multi-headed output to a long short term memory recurrent neural network with host data boundaries (BHI-LSTM) configured to generate the next time series step prediction. The inclusion of a VEC-DCNN layer allows the expansion coefficient to be dynamically adjusted, thereby reducing the error between the predicted next step and the actual next step, and the use of a multi-headed self actuation layer improves the ability of the output to conform the characteristics of the input time series.

In another example, any of the methods described herein can separably or in combination with any other methods described herein, the multi-headed self actuation layer includes an embedding layer configured to receive the generated dilated convolution, generate N time series vectors where N is a number of time steps in the generated dilated convolution and to generate a multi-headed output to the BHI-LSTM, wherein the multi-headed output includes N heads with each head corresponding to a distinct component of the N time series vectors. This layer structure further enhances the ability of the self actuation layer to correlate all of the related pieces of information from each input vector into a single head of the output.

In another example, any of the methods described herein can separably or in combination with any other methods described herein, the VEC-CNN includes an input layer for receiving the two-dimensional time series data set and a plurality of sequential dilated convolution layers. The multiple sequential dilated convolution layers assists the time series prediction model in capturing longer-term dependencies, thereby increasing the accuracy of the prediction.

In another example, any of the methods described herein can separably or in combination with any other methods described herein, the sequential dilated convolution layers have variable dilation rates. Variable dilation rates provide a tuning variable that enhances the ability of the CNN-LSTM to be tuned throughout operation of the method.

In another example, any of the methods described herein can separably or in combination with any other methods described herein, altering the CNN-LSTM model includes adjusting a dilation rate of at least convolution layer of the sequential convolution layers thereby allowing the adjustments to better fine tune the outputs of the CNN-LSTM based to meet the particular input host data.

In another example, any of the methods described herein can separably or in combination with any other methods described herein, the BHI-LSTM comprises an input layer, a block Hankel conversion layer configured to convert the multi-headed output to a block Hankel tensor, and a long short term memory (LSTM) model with host data boundaries layer including at least two LSTM layers. The LSTM layers improve the output by preventing the predictions from being too large or too small.

In another example, any of the methods described herein can separably or in combination with any other methods described herein, the block Hankel conversion layer converts the multi-headed output to a block Hankel tensor. Using a block Hankel tensor conversion layer improves the smoothness of the data set, making the resultant data easier to use for learning than raw data.

In another example a computer program product includes a memory storing instructions for causing a computer system to implement a process including receiving a one-dimensional time series data set and converting the time series data set to a two-dimensional time series data set. Providing the two-dimensional time series data set to an input of a convolutional neural network-long short term memory (CNN-LSTM) model. Generating a next time series step prediction of the two-dimensional time series data using the CNN-LSTM model and comparing the next time series step prediction to an actual next time series step. Responding to a difference between the next time series step prediction and the actual next time series step exceeding a first threshold by incrementing an outlier counter. The process responds to the outlier counter exceeding a predefined count value by altering the CNN-LSTM mode and generates a visualization of the next time series step prediction of the two-dimensional time series data. The computer program product further facilitates the distribution of the process to multiple computer systems, thereby enabling the process to be achieved at multiple locations.

In another example, any of the computer program products described herein can separably or in combination with any other computer program products described herein, include code for normalizing the two-dimensional time series data, providing the normalized two-dimensional time series data to an initial training model and generating a prediction using the initial training model simultaneously with generating the next time series step prediction, comparing an output of the initial training model with the actual next time series step and incrementing the outlier counter using the processor when a difference between the initial training model and the actual time step exceeds a second threshold. The further step advantageously allows the CNN-LSTM model to receive initial training and simultaneous training, thereby further improving a speed at which the model is refined to meet the needs of a specific input.

In another example, any of the computer program products described herein can separably or in combination with any other computer program products described herein, include a CNN-LSTM having an input layer for receiving the two-dimensional time series data set and providing the two-dimensional time series data set to a dilated convolutional layer using variable expansion coefficient (VEC-DCNN) configured to generate a dilated convolution of the two-dimensional time series data set, and a multi-headed self actuation layer receiving the generated dilated convolution and providing multi-headed output to a long short term memory recurrent neural network with host data boundaries (BHI-LSTM) configured to generate the next time series step prediction. The inclusion of a VEC-DCNN layer allows the expansion coefficient to be dynamically adjusted, thereby reducing the error between the predicted next step and the actual next step, and the use of a multi-headed self actuation layer improves the ability of the output to conform the characteristics of the input time series.

In another example, any of the computer program products described herein can separably or in combination with any other computer program products described herein, include the multi-headed self actuation layer having an embedding layer configured to receive the generated dilated convolution, generate N time series vectors where N is a number of time steps in the generated dilated convolution and to generate a multi-headed output to the BHI-LSTM, wherein the multi-headed output includes N heads with each head corresponding to a distinct component of the N time series vectors. This layer structure further enhances the ability of the self actuation layer to correlate all of the related pieces of information from each input vector into a single head of the output.

In another example, any of the computer program products described herein can separably or in combination with any other computer program products described herein, include code defining the VEC-CNN including an input layer for receiving the two-dimensional time series data set and a plurality of sequential dilated convolution layers. The multiple sequential dilated convolution layers assist the time series prediction model in capturing longer-term dependencies, thereby increasing the accuracy of the prediction.

In another example of the invention included herein, a system includes a client computer having a processor set, a communication fabric and a volatile memory, the volatile memory storing code configured to cause the processor set to generate a time series prediction using a convolutional neural network-long short term memory (CNN-LSTM) attention model by receiving, a one-dimensional time series data set and converting the time series data set to a two-dimensional time series data set. The two-dimensional time series data set is provided to an input of the CNN-LSTM model using the processor set. A next time series step prediction of the two-dimensional time series data is generated using the CNN-LSTM model. The next time series step prediction is compared to an actual next time series step. The process responds to a difference between the next time series step prediction and the actual next time series step exceeding a first threshold by incrementing an outlier counter and responds to the outlier counter exceeding a predefined count value by altering the CNN-LSTM model. A visualization of the next time series step prediction of the two-dimensional time series data is generated and output. The system provides a more accurate visual representation of a real time prediction of a next step of a time series data set.

In another example of the system, the CNN-LSTM includes an input layer for receiving the two-dimensional time series data set and providing the two-dimensional time series data set to a dilated convolutional layer using variable expansion coefficient (VEC-DCNN) configured to generate a dilated convolution of the two-dimensional time series data set, and a multi-headed self actuation layer receiving the generated dilated convolution and providing multi-headed output to a long short term memory recurrent neural network with host data boundaries (BHI-LSTM) configured to generate the next time series step prediction, and wherein the multi-headed self actuation layer includes an embedding layer configured to receive the generated dilated convolution, generate N time series vectors where N is a number of time steps in the generated dilated convolution and to generate a multi-headed output to the BHI-LSTM, wherein the multi-headed output includes N heads with each head corresponding to a distinct component of the N time series vectors. This CNN-LSTM architecture allows the CNN-LSTM model to receive initial training and simultaneous training, thereby further improving a speed at which the model is refined to meet the needs of a specific input.

Furthermore, each of the above example implementations and features may be used separately or in any combination with any number of the other example implementations and features.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Computing environment 100 contains an example of an environment for the execution of at least some of the computer code involved in performing the inventive methods, such as generating a time series prediction using a convolutional neural network—long short term memory (CNN-LSTM) attention model, at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 140, Cloud orchestration module 141, host physical machine set 142, virtual machine set 143, and container set 144.

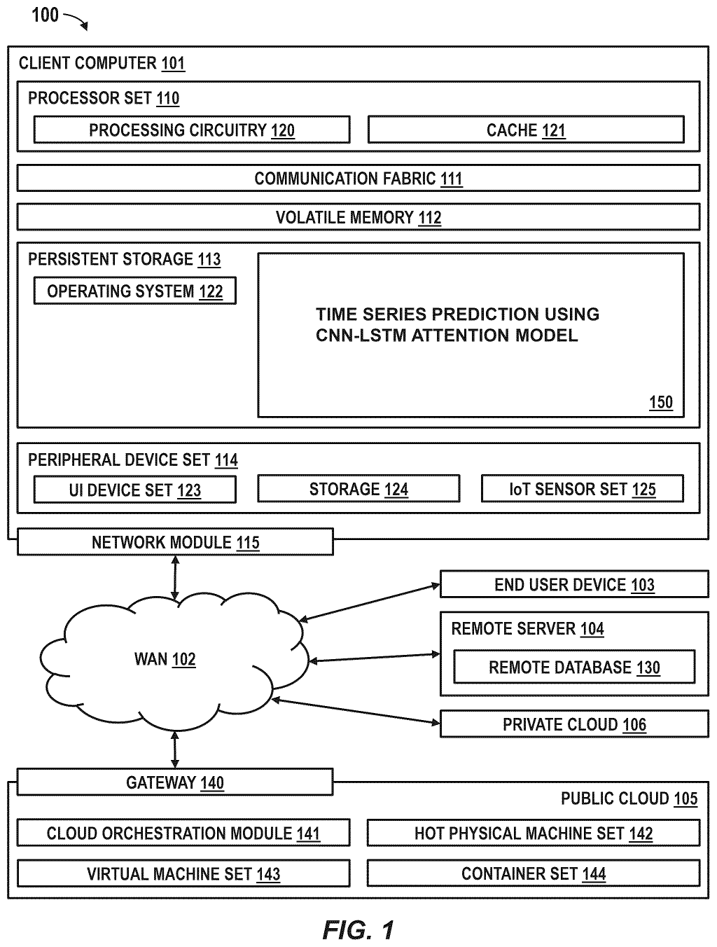

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 141. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Turning now to an overview of technologies that are more specifically relevant to aspects of the invention, most current real-time prediction models input all the time series data into a machine learning model for training. However, when the scale of data is large (e.g., there are a large number of time series factors), it is difficult for the machine learning model to output the prediction results in a short enough time period to provide useful real-time predictions. Furthermore, due to a varying number of indicators in each system, the machine learning algorithm needs to be adjusted every time in order to adapt to the shape of input when the model is applied to a new system.

Furthermore, current mainstream time series prediction algorithms are not effective in predicting host indicators. As a result of the lack of effectiveness, the structure of the prediction model needs to be adjusted to more accurately predict various indicators of the host.

Thus, it is desirable to use a time series model with fast training speed, multiple indicator inputs without considering the number of indicators and higher prediction accuracy for intelligent analysis.

Turning now to an overview of the aspects of the invention, one or more embodiments of the invention address the above-described shortcomings of the prior art by converting an input multi-index time series from a one-dimensional input to a two-dimensional input. Once converted to two dimensional, the code block 150 fixes a maximum number of input indicators of the two-dimensional input to be N indicators. While described as an example embodiment where N is 16, it is appreciated that the number of indicators (N) may be adapted to the needs of a given prediction and is not limited to 16 indicators. The prediction models adopt a two-dimensional dilated convolutional layer using variable expansion coefficient (VEC-DCNN), multi-head self-attention mechanism which integrates host data sources, and adopts a long short term memory recurrent neural network with host data boundaries (BHI-LSTM) which takes characteristics of the host time series into account. Finally, any outliers are counted while predicting, and a machine learning model is trained in real time when the outliers reach a predefined outlier threshold.

The above-described aspects of the invention address the shortcomings of the prior art by using a two-dimensional time series as fixed input. The two-dimensional fixed input can predict up to 16 indicators at one time and processes the time series into two-dimensional convolution. This allows an indicator to take into account the impact of other indicators on it when predicting. The prediction model includes dynamic two-dimensional dilated convolution, a multi-head self-attention mechanism with multi-source data fusion, and multi dimension training long short term memory (MDT-LSTM) that that consider the historical maximum and minimum values of a host. Consideration of the maximum and minimum values of the host improves the accuracy of host time series prediction.

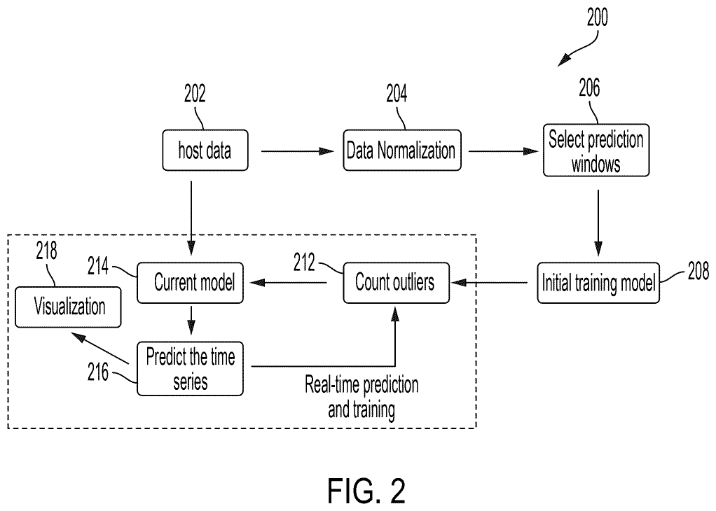

Turning now to a more detailed description of aspects of the present invention, FIG. 2 depicts a general process flow 200 for providing real time prediction and training 210 using a CNN-LSTM model.

The process flow 200 supports fixed input of two-dimensional time series, the time series and indicators are the two dimensions of input. There is often a relationship between indicators, and the time series is converted into two dimensions in order to allow the relationship to become apparent. In the example system, the maximum number of indicators that can be input into the algorithm is 16 indicators, and the number of prediction windows is 16. This allows the input size to be a two-dimensional fixed value of 16*16. The process converts a one-dimensional time series into a two-dimensional time series and accounts for the influence between various indicators. In alternate examples the maximum number of indicators that can be input is N, which allows for the input size to be a two-dimensional fixed value of N*N.

The process flow 200 initially receives time series data 202 from a host data source and converts the time series data into the two-dimensional time series at a host data step 202. The conversion is accomplished by converting the input data into a two-dimensional matrix. The vertical direction of the two-dimensional matrix is the time series dimension, and the horizontal direction of the two-dimensional matrix is an indicator dimension. The input matrix is fixed at 16*16, and any empty indicator columns are filled with 0s.

The two-dimensional time series is then normalized in a data normalization step 204, and 16 prediction windows are selected in a select prediction windows step 206. By way of example, a selection may opt to predict the last 1 minute worth of time series data using a continuous 16-minute time series. The selected data is provided to an initial training model 208 which sets an error threshold. When the error of the time series at a certain moment is greater than the error threshold, an outlier count value is increased in a count outliers step 212. When the outlier count reaches or exceeds a threshold, a current prediction model 214 is adjusted to correct for the outliers.

Simultaneously with the training branch at steps 204, 206, and 208, the time series data 202 is provided to the current prediction model 214. The current prediction model provides a prediction of the next data point in the time series in a predict the time series step 216, and the predicted time series is output in a visualization step 218. In addition, when the predicted time series from step 216 is off by more than the threshold, the error is provided to the count outliers step 212 causing the outlier count value to increase.

The process flow 200 includes end-to-end pre-processing and multi-dimensional data correlation weight integration.

The process flow 200 performs end-to-end artificial pre-processing of the host time series by first collecting host data, then handling any missing data, outliers and noise. The process flow 200 uses the time variable as an index and then normalizes the time series. Lastly the time series is divided into a training set and a test set. The process flow 200 can directly transform raw host data into a two-dimensional time series data set for algorithm training and testing.

The process flow 200 further incorporates multi-dimensional data correlation and weight integration. When there are multiple indicators in the host time series, such as CPU usage, memory usage, disk utilization, etc. the process flow 200 deeply analyzes the relationships between the multidimensional data and discovers the numerical connections between them. This correlation information is then converted into feature weights to ensure that the model better captures the relationships between multidimensional data, thereby improving prediction accuracy.

Elements of the weight integration include correlation analysis using random forest to find the relationship between different indicators and understand the correlation between indicators, weight allocation based on the results of correlation analysis such that each indicator is assigned a weight to reflect its importance in the overall prediction, and input data using weighted indicators as input to the model.

The multi-dimensional data correlation and weight integration makes the model more capable of data understanding and data correlation, thereby improving the quality of time series predictions.

With continued reference to FIGS. 1 and 2, FIG. 3 illustrates an example CNN-LSTM attention model 300 used to implement the real time prediction and training 210 of FIG. 2. The general CNN-LSTM attention model 300 is implemented as the current model 214 through training and application of reward/penalty weights to various factors of the time series data.

After the time series host data has been converted into two dimensions, the two-dimensional time series data is provided to the CNN-LSTM attention model 300 (alternately referred to as the attention model 300). The attention model 300 receives the two dimension time series data at an input layer 301. The attention model 300 then uses a three layer two-dimensional dilated convolution layer with variable expansion coefficient (2D VEC-DCNN 302) to provide a dilated convolution of the two-dimensional time series data. The dilated convolution is integrated into host data sources using a multi-head self-attention mechanism 304. An output of the self-attention mechanism 304 is provided to a BHI-LSTM 306 which generates the output prediction 308 (the predict time series step 216 of the process flow 200).

Application of the attention model 300 to host time series indicator predictions provides more accurate and faster prediction results than can be achieved using the single dimension time series data inputs and existing machine learning models.

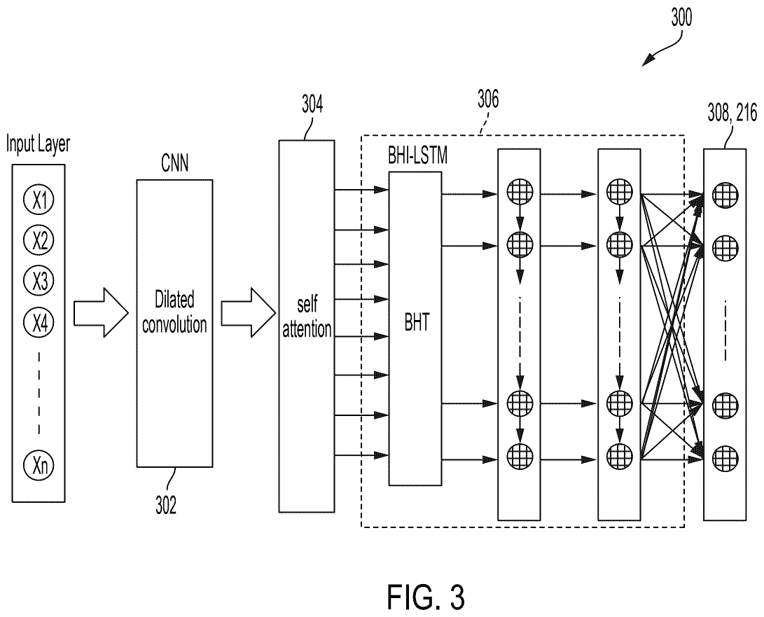

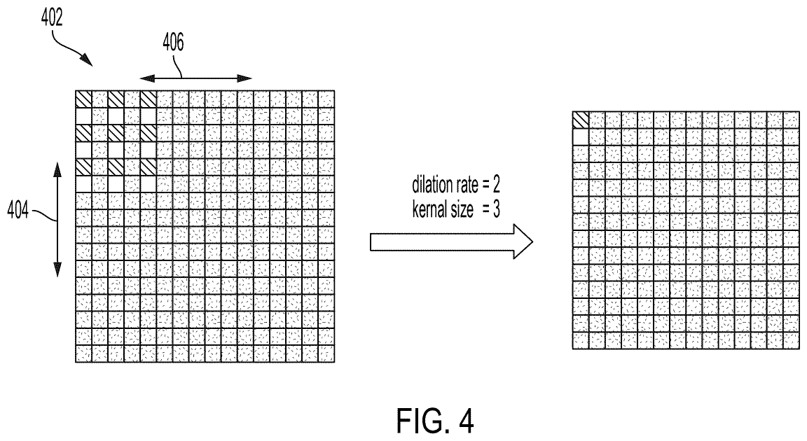

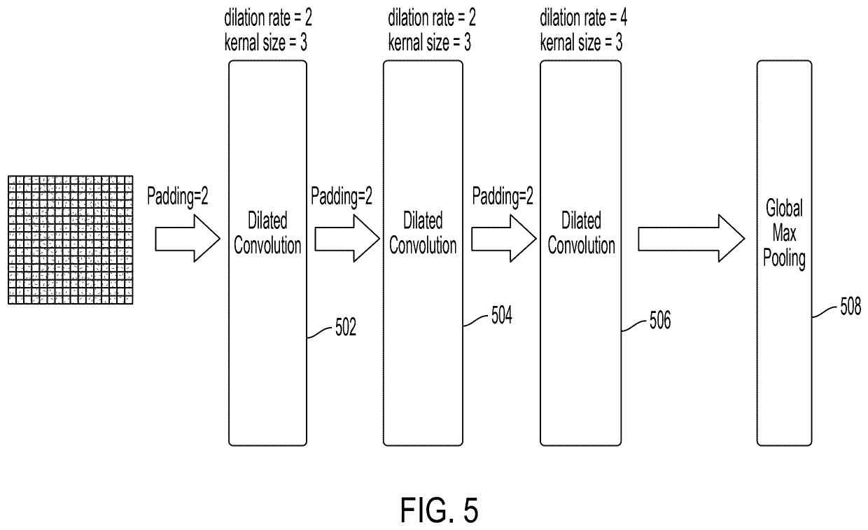

With continued reference to FIGS. 1-3, FIG. 4 illustrates an operation of a single layer of the 2D VEC-CNN 302 on a 16 by 16 two-dimensional time series 402 in one example and FIG. 5 illustrates three sequential layers 502, 504, 506 of the 2D VEC-CNN 302 of FIG. 3 in one example.

The 16 by 16 two-dimensional time series 402 has a vertical dimension of the time series 404 and a horizontal dimension for the indicators 406. Each dimension has a fixed input size of 16 entries. Using dilated convolution allows the convolution operation to skip certain time series, thereby expanding a receptive field and obtaining a longer time series trend. In addition when the mean absolute error (MAE) is increased, expansion coefficients can be dynamically adjusted and the adjustment direction reduces the error between the true value and a predicted value.

This 2D VEC-CNN 302 uses three dilated convolutional layers 502, 504, 506 applied to the two-dimensional time series data 402, when the expansion coefficient of the first layer 502 and second layer 504 is 2 and the expansion coefficient of the third convolutional layer is 4. Use of the sequential three layer dilated convolution allows the time series prediction model to better capture longer-term dependencies and improves the accuracy of the prediction results. The output of the third layer 506 is input into a global max pooling layer 508 which is provided to the multi-head self-attention mechanism 304.

In a practical implantation, the expansion coefficient of each layer 502, 504, 506 can be adjusted in real time based on the prediction results in response to the outliers exceeding a set value.

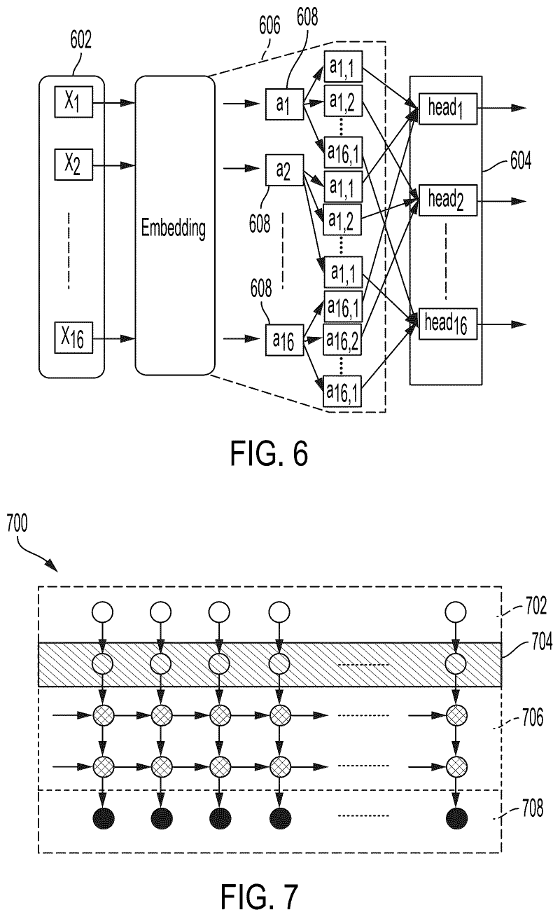

In addition to indicator data provided from the host data, the process flow 200 integrates other related data sources including network traffic, application performance data, user logs, and the like when making predictions. The other related data is considered in the multi-head self-attention mechanism 304 illustrated in FIG. 6 with an input 602 being 16 sequential entries of the two-dimensional time series data and the output 604 being 16 heads. In alternate examples, the input 602 may be N sequential entries of the two-dimensional time series data and the output 604 is N heads. Providing an output of the N heads conforms the output to the characteristics of the two-dimensional time series data.

An embedding layer 606 includes 16 time series vectors 608 and selects 16 pieces of information in parallel for each time series vector 608. As there are 16 heads in the output, an i-th head gathers the i-th information of each time series vector 608 and achieves the self-attention.

With continued reference to FIGS. 1-6, FIG. 7 illustrates a BHI-LSTM 700 according to one example. An input layer 702 receives the host time series data and provides the host time series data to a conversion block 704 which converts the data host time series data into a block Hankel tensor. The block Hankel tensor is used as an input for a two-layer LSTM 706 which provides an output at an output layer 708. The BHI-LSTM 700 is tailored for the specific time series data being received. In addition to considering past indicator data, a maximum and minimum value of the historical indicators is also considered.

Block Hankel tensors provide good data properties including low rank and smoothness and the use of a block Hankel tensor makes it easier to learn and train than raw data. In order to process the host time series into a block Hankel tensor, the conversion block 704 assumes that the time series of host indicators is t=(t1, t2, t3, . . . , tn). This series of host indicators is converted into Hankel matrix Dτ (t):

$${D}_{τ} ( t ) = [ \begin{matrix}{t}_{1} & {t}_{2} & ⋯ & {t}_{n - τ + 1} \\ {t}_{2} & {t}_{3} & ⋯ & {t}_{n - τ} \\ ⋮ & ⋮ & ⋱ & ⋮ \\ {t}_{τ} & {t}_{τ + 1} & ⋯ & {t}_{n}\end{matrix} ]$$

As the LSTM is applied to the host time series data, in addition to considering past and present inputs, the LSTM considers maximum and minimum values of the host's historical indicators. This comparison prevents predictions from being too large (exceeding the maximum historical indicator) or too small (being below the minimum historical indicator). The historical maximum and minimum are applied using:

$${f}_{t} = Adaptive LeakyReLU ( Wf \cdot [ {ht}_{- 1} , xt , {uppert}_{- 1} , {lowert}_{- 1} ] ) + {b}_{f}$$

$${i}_{t} = Adaptive LeakyReLU ( Wi \cdot [ {ht}_{- 1} , xt , {uppert}_{- 1} , {lowert}_{- 1} ] ) + {b}_{i}$$

$${o}_{t} = Adaptive LeakyReLU ( Wo \cdot [ {ht}_{- 1} , xt , {uppert}_{- 1} , {lowert}_{- 1} ] ) + {b}_{o}$$

Where fₜ is a forget value, iₜ is an input value and oₜ is an output value, and where uppert₋₁ and lowert₋₁ represent the upper and lower limits of the host's indicator value within 0₋ₜ₋₁, and the leakage rate provided by Adaptive LeakyReLU is adapted in real time according to:
leakage_rate=initial_rate*(1−exp (−k*epoch)), with initial_rate being the initial leakage rate set at a start of training, k being a hyperparameter that controls a rate of change of the leakage rate, and epoch being the current round of training.

Using this process, the leakage rate will gradually increase so that the model can make more use of nonlinear information at later stages of training/implementation, thereby improving the prediction accuracy.

With reference to all of FIGS. 1-7, one example implementation of the process flow 200 is in predicting operational aspects of a hardware upgrade in a computer system. When a user desires to predict a trend of multiple indicators of central processing unit (CPU) memory and other hardware after a host is upgraded, the user can utilize the process flow 200 to provide a visual display of the predicted curve compared to the real curve. Based on this visualization, the user can reasonably arrange various resources of a server to avoid resource shortages or waste.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, at a processor, a one-dimensional time series data set and converting the time series data set to a two-dimensional time series data set using a processor;
providing the two-dimensional time series data set to an input of a convolutional neural network-long short term memory (CNN-LSTM) model using the processor;
generating a next time series step prediction of the two-dimensional time series data using the CNN-LSTM model;
comparing the next time series step prediction to an actual next time series step and responding to a difference between the next time series step prediction and the actual next time series step exceeding a first threshold by incrementing an outlier counter using the processor, and responding to the outlier counter exceeding a predefined count value by altering the CNN-LSTM model; and
generating a visualization of the next time series step prediction of the two-dimensional time series data.

2. The computer-implemented method of claim 1, further comprising normalizing the two-dimensional time series data, providing the normalized two-dimensional time series data to an initial training model and generating a prediction using the initial training model simultaneously with generating the next time series step prediction, comparing an output of the initial training model with the actual next time series step and incrementing the outlier counter using the processor when a difference between the initial training model and the actual time step exceeds a second threshold.

3. The computer-implemented method of claim 1, wherein the CNN-LSTM comprises:
an input layer for receiving the two-dimensional time series data set and providing the two-dimensional time series data set to a dilated convolutional layer using variable expansion coefficient (VEC-DCNN) configured to generate a dilated convolution of the two-dimensional time series data set; and
a multi-headed self actuation layer receiving the generated dilated convolution and providing multi-headed output to a long short term memory recurrent neural network with host data boundaries (BHI-LSTM) configured to generate the next time series step prediction.

4. The computer-implemented method of claim 3, wherein the multi-headed self actuation layer includes an embedding layer configured to receive the generated dilated convolution, generate N time series vectors where N is a number of time steps in the generated dilated convolution and to generate a multi-headed output to the BHI-LSTM, wherein the multi-headed output includes N heads with each head corresponding to a distinct component of the N time series vectors.

5. The computer-implemented method of claim 3, wherein the VEC-CNN includes an input layer for receiving the two-dimensional time series data set and a plurality of sequential dilated convolution layers.

6. The computer-implemented method of claim 5, wherein the sequential dilated convolution layers have variable dilation rates.

7. The computer-implemented method of claim 6, wherein altering the CNN-LSTM model includes adjusting a dilation rate of at least convolution layer of the sequential convolution layers.

8. The computer-implemented method of claim 3, wherein the BHI-LSTM comprises an input layer, a block Hankel conversion layer configured to convert the multi-headed output to a block Hankel tensor, and a long short term memory (LSTM) model with host data boundaries layer including at least two LSTM layers.

9. The computer-implemented method of claim 8, wherein the block Hankel conversion layer converts the multi-headed output to a block Hankel tensor.

10. A method comprising:
receiving a one-dimensional time series data set and converting the time series data set to a two-dimensional time series data set;
providing the two-dimensional time series data set to an input of a convolutional neural network-long short term memory (CNN-LSTM) model;
generating a next time series step prediction of the two-dimensional time series data using the CNN-LSTM model;
comparing the next time series step prediction to an actual next time series step and responding to a difference between the next time series step prediction and the actual next time series step exceeding a first threshold by incrementing an outlier counter, and responding to the outlier counter exceeding a predefined count value by altering the CNN-LSTM model; and
generating a visualization of the next time series step prediction of the two-dimensional time series data.

11. The method of claim 10, further comprising normalizing the two-dimensional time series data, providing the normalized two-dimensional time series data to an initial training model and generating a prediction using the initial training model simultaneously with generating the next time series step prediction, comparing an output of the initial training model with the actual next time series step and incrementing the outlier counter when a difference between the initial training model and the actual time step exceeds a second threshold.

12. The method of claim 10, wherein the CNN-LSTM comprises:
an input layer for receiving the two-dimensional time series data set and providing the two-dimensional time series data set to a dilated convolutional layer using variable expansion coefficient (VEC-DCNN) configured to generate a dilated convolution of the two-dimensional time series data set; and
a multi-headed self actuation layer receiving the generated dilated convolution and providing multi-headed output to a long short term memory recurrent neural network with host data boundaries (BHI-LSTM) configured to generate the next time series step prediction.

13. The method of claim 12, wherein the multi-headed self actuation layer includes an embedding layer configured to receive the generated dilated convolution, generate N time series vectors where N is a number of time steps in the generated dilated convolution and to generate a multi-headed output to the BHI-LSTM, wherein the multi-headed output includes N heads with each head corresponding to a distinct component of the N time series vectors.

14. The method of claim 12, wherein the VEC-CNN includes an input layer for receiving the two-dimensional time series data set and a plurality of sequential dilated convolution layers.

15. The method of claim 14, wherein the sequential dilated convolution layers have variable dilation rates.

16. The method of claim 15, wherein altering the CNN-LSTM model includes adjusting a dilation rate of at least convolution layer of the sequential convolution layers.

17. The method of claim 12, wherein the BHI-LSTM comprises an input layer, a block Hankel conversion layer configured to convert the multi-headed output to a block Hankel tensor, and a long short term memory (LSTM) model with host data boundaries layer including at least two LSTM layers.

18. The method of claim 17, wherein the block Hankel conversion layer converts the multi-headed output to a block Hankel tensor.

19. A computer program product comprising:
a memory storing instructions for causing a computer system to implement a process including:
receiving a one-dimensional time series data set and converting the time series data set to a two-dimensional time series data set;
providing the two-dimensional time series data set to an input of a convolutional neural network-long short term memory (CNN-LSTM) model;
generating a next time series step prediction of the two-dimensional time series data using the CNN-LSTM model;
comparing the next time series step prediction to an actual next time series step and responding to a difference between the next time series step prediction and the actual next time series step exceeding a first threshold by incrementing an outlier counter, and responding to the outlier counter exceeding a predefined count value by altering the CNN-LSTM model; and
generating a visualization of the next time series step prediction of the two-dimensional time series data.

20. The computer program product of claim 19, wherein the process further includes normalizing the two-dimensional time series data, providing the normalized two-dimensional time series data to an initial training model and generating a prediction using the initial training model simultaneously with generating the next time series step prediction, comparing an output of the initial training model with the actual next time series step and incrementing the outlier counter when a difference between the initial training model and the actual time step exceeds a second threshold.

21. The computer program product of claim 19, wherein the CNN-LSTM comprises:
an input layer for receiving the two-dimensional time series data set and providing the two-dimensional time series data set to a dilated convolutional layer using variable expansion coefficient (VEC-DCNN) configured to generate a dilated convolution of the two-dimensional time series data set; and
a multi-headed self actuation layer receiving the generated dilated convolution and providing multi-headed output to a long short term memory recurrent neural network with host data boundaries (BHI-LSTM) configured to generate the next time series step prediction.

22. The computer program product of claim 21, wherein the multi-headed self actuation layer includes an embedding layer configured to receive the generated dilated convolution, generate N time series vectors where N is a number of time steps in the generated dilated convolution and to generate a multi-headed output to the BHI-LSTM, wherein the multi-headed output includes N heads with each head corresponding to a distinct component of the N time series vectors.

23. The computer program product of claim 21, wherein the VEC-CNN includes an input layer for receiving the two-dimensional time series data set and a plurality of sequential dilated convolution layers.

24. A system comprising:
a client computer having a processor set, a communication fabric and a volatile memory, the volatile memory storing code configured to cause the processor set to generate a time series prediction using a convolutional neural network-long short term memory (CNN-LSTM) attention model by:
receiving, a one-dimensional time series data set and converting the time series data set to a two-dimensional time series data set;
providing the two-dimensional time series data set to an input of the CNN-LSTM model using the processor set;
generating a next time series step prediction of the two-dimensional time series data using the CNN-LSTM model;
comparing the next time series step prediction to an actual next time series step and responding to a difference between the next time series step prediction and the actual next time series step exceeding a first threshold by incrementing an outlier counter, and responding to the outlier counter exceeding a predefined count value by altering the CNN-LSTM model; and
generating a visualization of the next time series step prediction of the two-dimensional time series data.

25. The system of claim 24, wherein the CNN-LSTM includes an input layer for receiving the two-dimensional time series data set and providing the two-dimensional time series data set to a dilated convolutional layer using variable expansion coefficient (VEC-DCNN) configured to generate a dilated convolution of the two-dimensional time series data set, and a multi-headed self actuation layer receiving the generated dilated convolution and providing multi-headed output to a long short term memory recurrent neural network with host data boundaries (BHI-LSTM) configured to generate the next time series step prediction, and wherein the multi-headed self actuation layer includes an embedding layer configured to receive the generated dilated convolution, generate N time series vectors where N is a number of time steps in the generated dilated convolution and to generate a multi-headed output to the BHI-LSTM, wherein the multi-headed output includes N heads with each head corresponding to a distinct component of the N time series vectors.
